(19) United States
(12) Patent Application Publication
(10) Pub. No.: US 2004/0240345 A1
(43) Pub. Date: Dec. 2, 2004

(54) Optical disk apparatus and optical disk processing method

(75) Inventor: You Yoshioka, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/819,171

(22) Filed: Apr. 7, 2004

(30) Foreign Application Priority Data
May 30, 2003 (JP) 2003-154253

(51) Int. Cl. G11B 5/09; G11B 7/00

(52) U.S. Cl. 369/47.27; 369/47.28; 369/124.1

(57) ABSTRACT

The invention is an optical disk apparatus including a generating unit which generates an RF signal and a wobble signal detected from the optical disk, a detection unit which detects a sink or a VFO on the optical disk on the basis of the wobble signal, an adjustment unit which adjusts the RF signal on the basis of timing of the detection signal detected by the detection unit, and a processing unit which reproduces the RF signal adjusted by the adjustment unit. In the optical disk of the invention, adjustment of an RF signal and the like can be easily performed by recognizing a VFO position, even in a header is not provided like the next-generation DVD-RAM.

### CROSS-REFERENCE TO RELATED APPLICATIONS

This application is based upon and claims the benefit of priority from prior Japanese Patent Application No. 2003-154253, filed May 30, 2003, the entire contents of which are incorporated herein by reference.

### BACKGROUND OF THE INVENTION

1. Field of the Invention

The present invention relates to an optical disk apparatus, particularly to the optical disk apparatus and an optical disk processing method for dealing with a wobble signal.

2. Description of the Related Art

In recent years, the optical disk apparatus is improved and the optical disk apparatus becomes widespread. Even in technologies of this field, higher-level technology is demanded. One of the technologies of the filed is to detect a wobbled pre-groove provided on an optical disk to utilize a wobble clock generated corresponding to the wobbled pre-groove.

In the prior art (Jpn. Pat. Appln. KOKAI Publication No. 2002-260237) concerned with the wobble clock signal, there is disclosed an example in which a position of a light beam spot can be correctly controlled in a central portion of an information recording track, even if a land pre-pit is formed while the land pre-pit is biased toward an inner track or an outer radius of the land. Jpn. Pat. Appln. KOKAI Publication No. 2002-260237 is one in which the position control of a shift in the light beam spot is performed by utilizing the detected wobble signal, and Jpn. Pat. Appln. KOKAI Publication No. 2002-260237 is the prior art utilizing the wobble signal.

However, in the prior art described above, there is the problem that the above prior art does not described about detection of a VFO (Variable Frequency Oscillator) in the optical disk in the case where a header is not provided like the next-generation DVD (Digital Versatile Disk)-RAM (Random Access Memory) or the like.

### BRIEF SUMMARY OF THE INVENTION

According to an aspect of the invention, there is provided an optical disk apparatus comprising: a generating unit which generates a wobble signal corresponding to a wobbled groove or an RF signal corresponding to storage information on an optical disk on the basis of a reflected light beam detected from the optical disk; a detection unit which detects a detection signal indicating a predetermined position on the optical disk on the basis of the wobble signal generated by the generating unit; an adjustment unit which adjusts the RF signal on the basis of timing of the detection signal detected by the detection unit; and a processing unit which reproduces information stored in the optical disk on the basis of the RF signal adjusted by the adjustment unit.

### BRIEF DESCRIPTION OF THE SEVERAL VIEWS OF THE DRAWING

FIG. 1 is a block diagram showing an optical disk apparatus which is of an embodiment of the invention;

FIG. 2 is a block diagram showing the optical disk apparatus which is of another embodiment of the invention;

FIG. 3 is an explanatory view showing a relationship between a sink detected by the optical disk apparatus which is of an embodiment of the invention and a VFO;

FIG. 4 is an explanatory view showing a relationship between the sink detected by the optical disk apparatus which is of an embodiment of the invention and phase inversion;

FIG. 5 is a graph illustrating potential level adjustment of an RF signal controlled by the optical disk apparatus which is of an embodiment of the invention; and

FIG. 6A and FIG. 6B are graphs illustrating timing adjustment of the RF signal controlled by the optical disk apparatus which is of an embodiment of the invention.

### DETAILED DESCRIPTION OF THE INVENTION

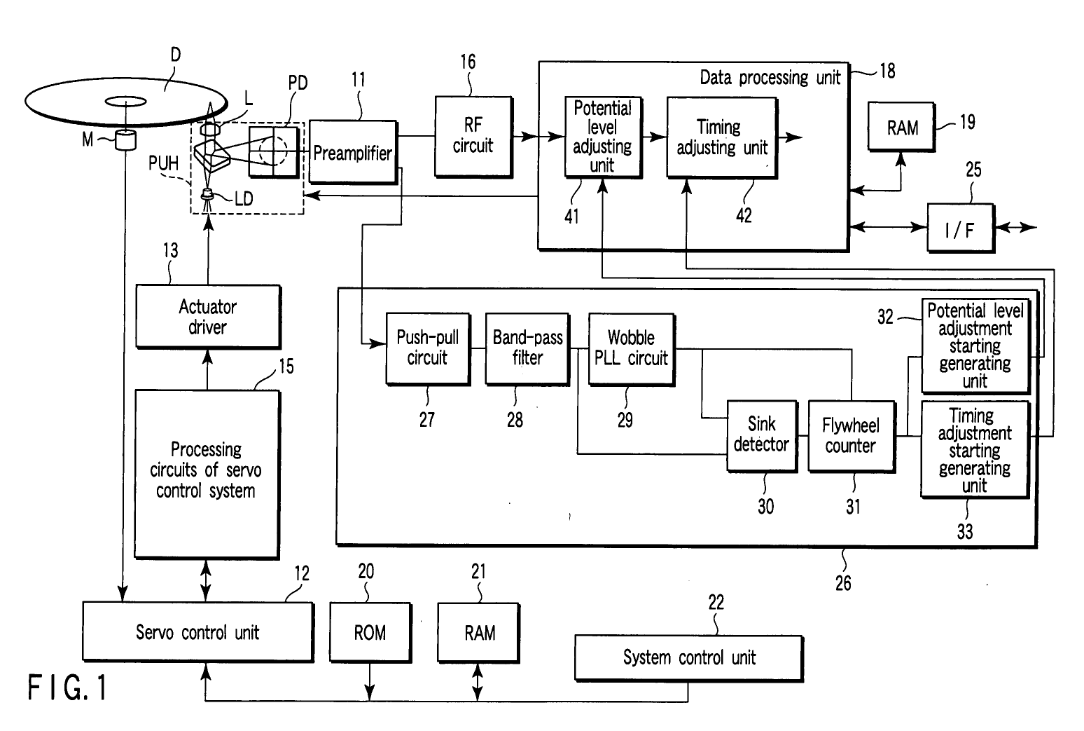

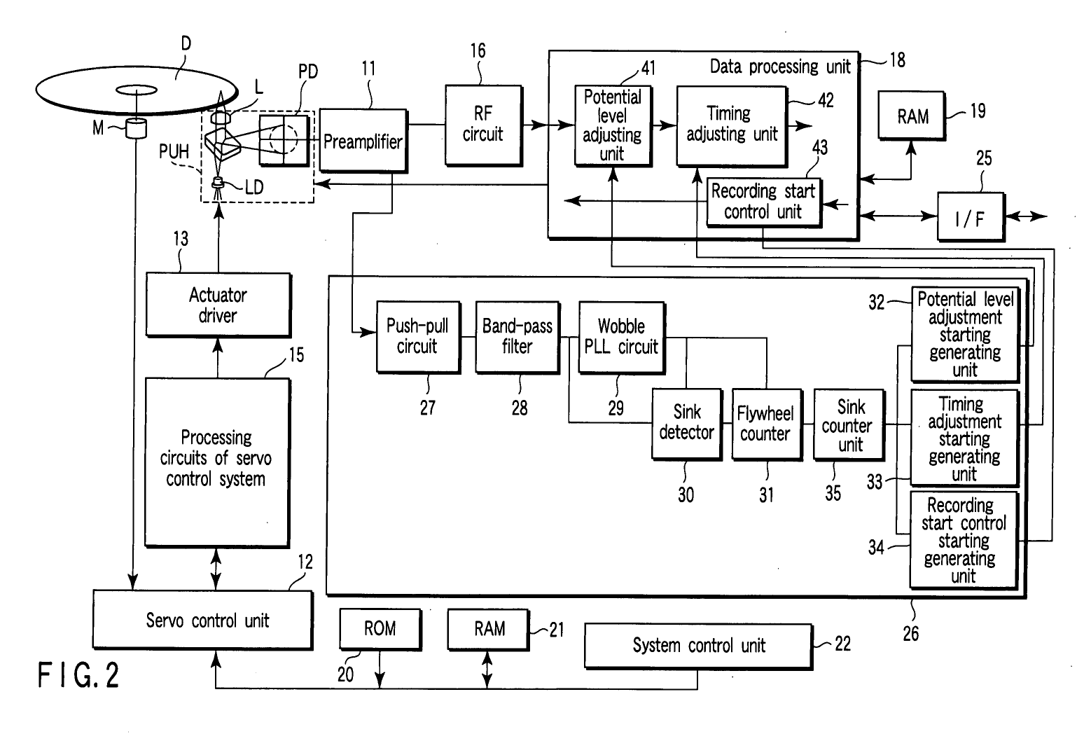

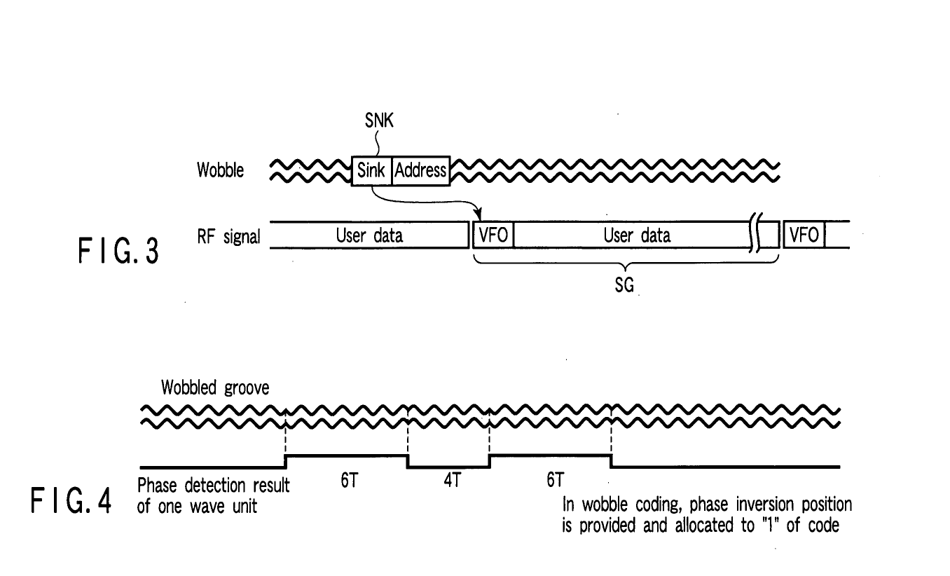

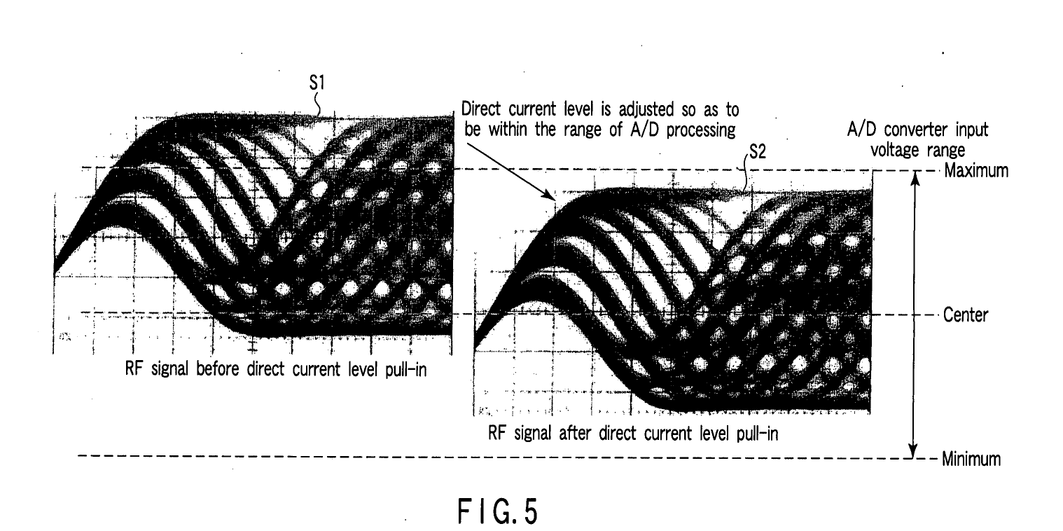

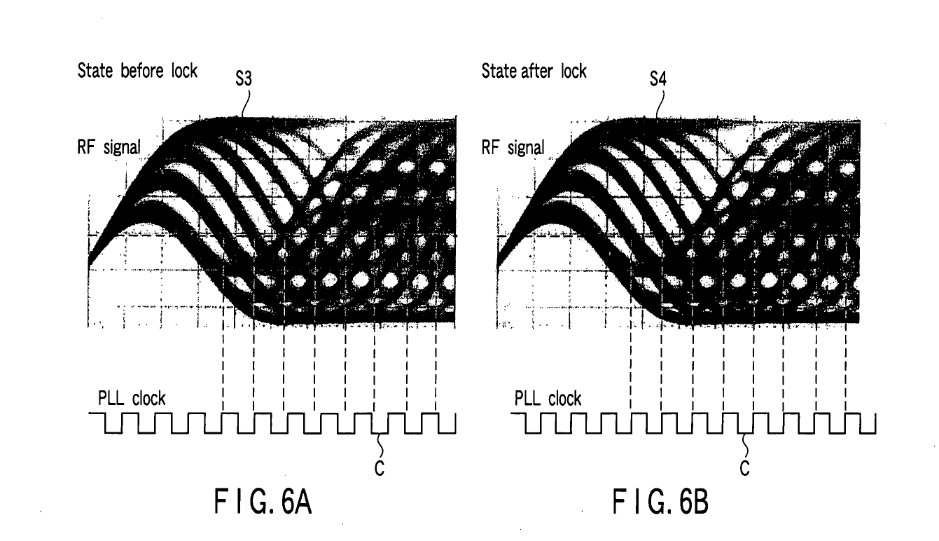

The optical disk apparatus which is of an embodiment of the invention will be described in detail below referring to the accompanying drawings. FIG. 1 is the block diagram showing an optical disk apparatus which is of an embodiment of the invention, FIG. 2 is the block diagram showing the optical disk apparatus which is of another embodiment of the invention, FIG. 3 is the explanatory view showing a relationship between a sink detected by the optical disk apparatus which is of an embodiment of the invention and a VFO, FIG. 4 is the explanatory view showing a relationship between the sink detected by the optical disk apparatus which is of an embodiment of the invention and phase inversion, FIG. 5 is the graph illustrating potential level adjustment of an RF signal controlled by the optical disk apparatus which is of an embodiment of the invention, and FIG. 6A and FIG. 6B are the graphs illustrating timing adjustment of the RF signal controlled by the optical disk apparatus which is of tan embodiment of the invention.

### Optical Disk Apparatus according to the Invention

(Basic Configuration and Operation)

In FIG. 1, an optical disk apparatus A which is of an embodiment of the invention includes a ROM 20 and a RAM 21 which are a storage area and a system control unit 22 which controls overall operation. The optical disk apparatus A also includes a rotary motor M for a driving system, which rotates an optical disk D at predetermined number of revolutions, and a servo control unit 12. Further, the optical disk apparatus A includes a pickup head PUH which writes information in the optical disk D and reads out the information from the optical disk D. The pickup head PUH includes an objective lens L, a photodetector PD such as a four-channel photodetector, and a laser diode LD which emits a laser beam.

The servo control unit 12 is connected to processing circuits of servo control system 15. The processing circuits of servo control system 15 contain an objective lens guiding circuit, a focus control circuit, an objective lens driving signal switch, an objective lens driving circuit, a wobble signal detector and the like, which are not shown. The processing circuits of servo control system 15 perform focus retracting operation and the like.

The optical disk apparatus A also includes a preamplifier 11 to which a detection signal is supplied from the photodetector PD of the pickup head PUH, an RF circuit 16 to which an amplified signal is supplied from the preamplifier 11, and a wobble PLL circuit 26. The RF circuit 16 includes a data processing unit 18 which perform modulating/demodulating processing or ECC processing to a signal to be recorded which is given from the outside or the detection signal which is detected by the pickup head PUH. The data processing unit 18 is connected to a RAM 19 which provides a working area and an interface (I/F) 25 which exchanges the signal between the optical disk apparatus A and an external device.

The data processing unit 18 includes a potential level adjusting unit 41 which adjusts a potential level of the RF signal from the RF circuit 16 and a timing adjusting unit 42 which adjusts timing of the RF signal. Further, in the optical disk apparatus which is of another embodiment of the invention shown in FIG. 2, the data processing unit 18 includes a recording start control unit 43.

A wobble control unit 26 which is of a feature of the invention includes a push-pull circuit 27 to which detection signals (A, B, C, and D) are supplied from the preamplifier 11, a band-pass filter 28 to which output of the push-pull circuit 27 is supplied, a wobble PLL circuit 29 to which the output of the band-pass filter 28 is supplied, a sink detection circuit 30 to which the output of the band-pass filter 28, a flywheel counter 31 to which the outputs of the sink detection circuit 30 and the wobble PLL circuit 29, a potential level adjustment starting generating unit 32, and a timing adjustment starting generating unit 33. In the potential level adjustment starting generating unit 32 and the timing adjustment starting generating unit 33, each starting signal is output by the output of the flywheel counter 31. Further, in FIG. 2, the wobble control unit 26 includes a sink counter 35 in the subsequent stage of the flywheel counter 31. The sink counter 35 securely detects a VFO position by counting the number of sinks.

In the above configuration, the system control unit 22 uses a RAM 21 as the working area and performs the predetermined operation according to a program including the invention which is recorded in a RAM 20. The optical disk D is irradiated with a light beam output from the pickup head PUH. The reflected light beam from the optical disk D is converted into an electric signal by the preamplifier 11. The electric signal is input to the data processing unit 18 through the RF circuit 16.

The objective lens guiding circuit, the focus control circuit, the objective lens driving signal switch, the objective lens driving circuit, the wobble signal detector, and the like, which are not shown and are includes in the processing circuits of servo control system 15, perform the focus retracting operation and the like.

In data writing operation, by using a writing clock generated by a write channel circuit (not shown), the data processing unit 18 adds an error detection code (EDC) and an ID to the data transmitted through an I/F 25, performs data scramble processing to the data in order to stabilize the servo, adds an error correction code (ECC) to the data, and adds a synchronizing signal to the data. Further, the data processing unit 18 modulates the signals except the synchronizing signal and transmits the signals except the synchronizing signal to a write power control signal unit (not shown). The signals except the synchronizing signal are written in a medium through a laser diode driving circuit (not shown) by optimum write strategy for the corresponding medium.

In data readout operation, the detection signal from the pickup head PUH is amplified by the preamplifier 11, and an RF signal generated by the RF circuit 16 is transmitted to a read buffer (not shown) and a PLL circuit (not shown) through an optimum equalizer. Channel data is read in the read buffer with a readout clock generated by the PLL circuit. In the data which has been read, synchronized symbol data is read out by the data processing unit 18. Then, error correction processing and disk scramble processing are performed, and the data is transferred to the external device or the like through an I/F 25.

### VFO Detection Processing

(Overview)

Then, referring to the drawings, detection operation of a VFO in the disk and the like will be described in detail by the operation of the wobble control unit 26 according to the invention.

The next-generation DVD-RAM or the like have no header. Accordingly, sometimes there is a possibility that detection of a VFO area becomes difficult. In the RAM disk in which wobble address coding has been performed, as shown in FIG. 3, it is possible to estimate the VFO area which is located at a leading end of one segment SG by specifying a sink SNK position of the wobble.

When a sink pattern SNK is detected from the wobble signal W, the timing of the detected sink pattern SNK can perform the starting of the RF signal processing system. Since the portion started from the VFO portion is one in which the recording is newly started, as indicated by an arrow shown in FIG. 3, delay of a predetermined period is performed from the sink timing of the wobble, and a signal for starting is output at the position where the VFO portion is started.

A procedure of detecting the specific sink from a wobble signal W will be described referring to FIG. 3 and FIG. 4. A repetition which is started from the wobble sink and followed by address data is referred to as one wobble unit.

In this disk system, “0” and “1” are indicated by inverting a phase of the wobble signal. A wobbled groove shown in FIG. 4 has four phase inversion points, and intervals between the phase interval positions are 6 periods, 4 periods, and 6 periods respectively. Assuming that the sink patterns are defined as “1” of 6 periods, “0” of 4 periods, and “1” of 6 periods, it is possible to detect the sink position when the phase inversion position is detected.

(Configuration and Operation)

The configuration and the operation in which the sink and a VFO are detected, the RF signal is adjusted on the basis of a timing signal indicating the VFO position, and recording processing is controlled will be described in detail below.

The wobbling, i.e. the groove which vibrates in a radial direction is formed in the optical disk D so that the wobbling becomes a clue to obtain a time base of read channel signal processing such as making of a write clock corresponding to a change in linear velocity of the disk. In the optical disk apparatus, the wobble signal period is reproduced, and a clock for processing is generated while the clock for processing synchronizes with the wobble signal period. As described above, the sink for physical address and the sink for detecting the physical address are coded by phase modulation in the groove in which the wobbling is processed.

The laser beam emitted from the laser diode LD is focused onto a face of the disk through the objective lens L, the detection signal based on the reflected light beam is guided to the photodetector PD. The photodetector PD include, e.g. a four-divided photo acceptance surface, and the photodetector PD discriminates light intensity according to a diffraction direction. Since the outputs of the photo acceptance surfaces are a very small quantity of electric current, the outputs are amplified to large voltage by the preamplifier 11 so that subsequent processing is easy to perform.

The output signal of the preamplifier 11 is divided, and one of the divided outputs of the preamplifier 11 is input to the RF circuit 16. In the RF circuit 16, addition processing for reading the RF signal of the read channel is performed, and the generated RF signal is supplied to the data processing unit 18. The RF signal is supplied to a potential level adjusting unit 41 which is contained in the data processing unit 18. The output of the potential level adjusting unit 41 is supplied to a timing adjusting unit 42.

The starting signal is supplied from the potential level adjustment starting generating unit 32 in the wobble control unit 26 to the potential level adjusting unit 41, and the starting signal is supplied from the timing adjustment starting generating unit 33 to the timing adjusting unit 42. Therefore, level processing and timing processing of the RF signal is performed by proper timing (by synchronizing with a VFO).

FIG. 5 is the graph showing the adjustment performed by the potential level adjusting unit 41 of the RF signal and FIG. 6A and FIG. 6B are the graphs showing the adjustment performed by the timing adjusting unit 42. In FIG. 5, an RF signal S1 before direct current level pull-in is changed to an RF signal S2 after direct current level pull-in by the adjustment of the potential level adjusting unit 41. As can be seen from FIG. 5, the RF signal S2 is correctly adjusted to the center of the maximum and the minimum of an A/D converter input voltage range. The timing of the adjustment is performed by the timing which synchronizes with the VFO position where the recording data is started.

As shown in FIG. 6A and FIG. 6B, while the timing of an RF signal S3 before lock is shifted from a PLL clock C, an RF signal S4 after lock synchronizes with the PLL clock C by the adjustment of the timing adjusting unit 42. The timing in which the timing adjustment is performed is carried out by the timing which synchronizes with the VFO position where the recording data is started.

The RF signal in which the potential level and the timing are adjusted at proper timing is guided to correction processing and the like in the subsequent stage, and the appropriate processing is performed. Therefore, even in the case where the header is not provided like the next-generation DVD-RAM, the reproduction processing can be performed at the optimum timing in such a manner that the sink and the like are detected from the wobble signal and the VFO position is estimated at the timing of the detected sink.

As shown in FIG. 2, the recording start control starting generating unit 34 receives the timing signal corresponding to a VFO to supply a recording start control starting signal to the recording start control unit 43 in the data processing unit 18. This allows the recording processing of given information to be securely performed while the recording processing synchronizes with a VFO.

(Detection of Sink and Generation of Starting Signal)

Then, the detection of the sink of the wobble and the generation of the starting signal will be described in detail referring to FIG. 1 and FIG. 2. The output of the preamplifier 11 is also input to the push-pull circuit 27. In the push-pull circuit 27, a push-pull signal indicating balance of a radial diffraction light beam from the groove is operationally generated from the signal output from preamplifier 11. The detection of a frequency and the phase of the wobble signal and the detection of address data sink are performed by obtaining the state of the wobbling of the groove in the optical disk D, which appears in the push-pull signal.

In the push-pull signal generated by the push-pull circuit 27, a part of the unnecessary read channel RF signal and an unnecessary direct current component are attenuated by the band-pass filter 28. Then, the push-pull signal is supplied to the wobble PLL circuit 29 and the sink detector 30 in the form of the wobble signal W which substantially corresponds to the change in the wobble groove.

In the wobble PLL circuit 29, a wobble PLL signal WPLL which is of the signal close to a pure wobble clock (locked wobble signal) is synchronously oscillated on the basis of the wobble signal W, in which an S/N ratio is not good and the read channel RF signal and the like are contained. Since the wobble PLL signal WPLL has a flywheel effect by PLL, even if the wobble is phase modulation of the wobble has been performed by the sink or the address, the wobble PLL signal WPLL can continue the oscillation while the wobble PLL signal WPLL maintains the basic phase. The wobble PLL signal WPLL gives length information of one period of the wobble to the sink detector 30 and the flywheel counter 31.

In the whole optical disk system, the wobble frequency is multiplied by a fixed number and used for the generation of a bit clock during the recording or for frequency information in RF signal processing of the reproduction. However, the description is omitted here.

The sink detector 30 specifies the sink position defined in the above-described way by receiving the wobble signal W supplied from the band-pass filter 29 and the wobble PLL signal WPLL output from the wobble PLL circuit 29. That is to say, as shown in FIG. 3 and FIG. 4, in the wobble signal W supplied from the band-pass filter 28 and detects the sink on the basis of the phase inversions, the sink detector 30 detects the phase inversions of 6T, 4T, and 6T in wavelength unit of the locked wobble with reference to the phase of the locked wobble by the phase inversion point and the wobble period, and the sink detector 30 detects the sink on the basis of the phase inversion. When the sink detector 30 detects the sink, the sink detector 30 generates a flag, and the flag is input to the flywheel counter 31.

The flywheel counter 31 generates a wobble periodic signal (locked wobble) until the next wobble is detected by counting the wobble periodic signal. For example, the sink is provided at the about 1500-period wobble interval.

The flywheel counter 31 is provided to count the wobble period between the sinks. Thus, even in the case where the sink detector 30 fails the detection of the sink by influence of noise or the like, the sink detection signal can be securely supplied to the potential level adjustment starting generating unit 32, the timing adjustment starting generating unit 33, and the recording start control starting generating unit 34 in the subsequent stage by the action of the flywheel counter 31. As shown in FIG. 3, even in the case where the predetermined interval is present between the sink and a VFO, the timing signal corresponding to a VFO can be securely supplied to the subsequent stage by the delay function of the flywheel counter 31.

Further, for example, in the next-generation DVD-RAM, providing the sink counter unit 35 shown in FIG. 2 in the subsequent stage of the flywheel counter 31 can correspond to the case in which a VFO is provided in each 7 sinks. That is to say, when the sink is counted from the last VFO position with the sink detection signal from the flywheel counter 31, it is recognized that the next VFO is located at the position where the seventh sink is counted. Thus, even in the case where the plurality of sinks correspond to one VFO, the timing signal which synchronizes with a VFO or the like can be securely supplied to the potential level adjustment starting generating unit 32, the timing adjustment starting generating unit 33, and the recording start control starting generating unit 34 in the subsequent stage by providing the sink counter 35.

Even in the case of the disk in which the header is not provided like the next-generation DVD-RAM, the sink of the wobble signal is detected by the action of the wobble control circuit in the optical disk apparatus according to the invention, and the level adjustment and the timing adjustment of the RF signal can be performed at the timing corresponding to a VFO.

Although those skilled in the art can realize the invention by the various embodiments described above, various modifications of these embodiments could be easily made by those skilled in the art, and the invention can be applied to various modes without any inventive ability. Therefore, the invention is not limited to the above embodiments, but the invention covers broad scope which is consistent with the disclosed principles and novel features.

As described above, even in the case of the disk in which the header is not provided like the next-generation DVD-RAM, the invention can provide the optical disk apparatus and the optical disk processing method, in which the sink of the wobble signal is detected by using the wobble control unit and the level adjustment and the timing adjustment of the RF signal can be performed at the timing corresponding to a VFO.

What is claimed is:

1. An optical disk apparatus comprising:
a generating unit which generates a wobble signal corresponding to a wobbled groove or an RF signal corresponding to storage information on an optical disk on the basis of a reflected light beam detected from the optical disk;
a detection unit which detects a detection signal indicating a predetermined position on the optical disk on the basis of the wobble signal generated by the generating unit;
an adjustment unit which adjusts the RF signal on the basis of timing of the detection signal detected by the detection unit; and
a processing unit which reproduces information stored in the optical disk on the basis of the RF signal adjusted by the adjustment unit.

2. An optical disk apparatus according to claim 1, wherein the adjustment unit generates a starting signal for adjusting a potential level of the RF signal and adjusts the potential level of the RF signal on the basis of the starting signal.

3. An optical disk apparatus according to claim 1, wherein the adjustment unit generates the starting signal for adjusting timing of the RF signal and adjusts the timing of the RF signal on the basis of the starting signal.

4. An optical disk apparatus according to claim 1, further comprising:
a recording start control unit which controls recording start on the basis of the timing of the detection signal detected by the detection unit; and
a recording unit which performs recording in a storage area of the optical disk corresponding to a given signal by control of the recording start control unit.

5. An optical disk apparatus according to claim 1, wherein the detection unit detects a sink which is of the predetermined position by detecting a phase inversion point in each of wobble periods of a predetermined number in the wobble signal generated by the generating unit.

6. An optical disk apparatus according to claim 1, wherein the detection unit has a sink detection unit which detects the phase inversion points as the sink, in the case where the wobble signal generated by the generating unit has a first phase inversion point, a second phase inversion point which is apart from the first phase inversion point by 6 wobbles, a third phase inversion point which is apart from the second phase inversion point by 4 wobbles, and a fourth phase inversion point which is apart from the third phase inversion point by 6 wobbles.

7. An optical disk apparatus according to claim 1, wherein the detection unit has the sink detection unit which detects the sink by detecting the phase inversion point in each of wobble periods of the predetermined number in the wobble signal generated by the generating unit, and
a flywheel counter which recognizes the point, where the wobbles of the predetermined number have elapsed, as the next sink from the sink detected by the sink detection unit.

8. An optical disk apparatus according to claim 1, wherein the detection unit further has the sink detection unit which detects the sink by detecting the phase inversion point in each of wobble periods of the predetermined number in the wobble signal generated by the generating unit, and
a sink counter which counts the number of the sinks detected by the sink detection unit from the predetermined position and determines that the position of the sink where the number of the sinks becomes a certain number is next the predetermined position.

9. An optical disk apparatus comprising:
a generating unit which generates a wobble signal corresponding to a wobbled groove or an RF signal corresponding to storage information on an optical disk on the basis of a reflected light beam detected from the optical disk; and
a processing unit which adjusts the RF signal on the basis of the wobble signal generated by the generating unit.

10. An optical disk apparatus according to claim 9, wherein the processing unit adjusts one of a potential level and timing of the RF signal on the basis of the wobble signal.

11. An optical disk processing method comprising:
generating a wobble signal corresponding to a wobbled groove or an RF signal corresponding to storage information on an optical disk on the basis of a reflected light beam detected from the optical disk;
detecting a detection signal indicating a predetermined position on the optical disk on the basis of the wobble signal;
adjusting the RF signal on the basis of timing of the detection signal; and
reproducing information stored in the optical disk on the basis of the adjusted RF signal.

12. An optical disk processing method according to claim 11, wherein a starting signal for adjusting a potential level of the RF signal is generated and the potential level of the RF signal is adjusted on the basis of the starting signal in the adjustment.

13. An optical disk processing method according to claim 11, wherein the starting signal for adjusting timing of the RF signal is generated and adjusts the timing of the RF signal is adjusted on the basis of the starting signal in the adjustment.

14. An optical disk processing method according to claim 11, further comprising:
controlling recording start on the basis of the timing of the detected detection signal; and
performing recording in a storage area of the optical disk corresponding to a given signal by the control.

15. An optical disk processing method according to claim 11, wherein, in the detection, a sink which is of the predetermined position is detected by detecting a phase inversion point in each of wobble periods of a predetermined number in the wobble signal.

16. An optical disk processing method according to claim 11, wherein, in the detection, in the case where the wobble signal generated by the generating unit has a first phase inversion point, a second phase inversion point which is apart from the first phase inversion point by 6 wobbles, a third phase inversion point which is apart from the second phase inversion point by 4 wobbles, and a fourth phase inversion point which is apart from the third phase inversion point by 6 wobbles, these phase inversion points are detected as the sink.

17. An optical disk processing method according to claim 11, wherein, in the detection, the sink is detected by detecting the phase inversion point in each of wobble periods of the predetermined number in the wobble signal, and
the point where the wobbles of the predetermined number have elapsed is recognized as the next sink from the detected sink.

18. An optical disk processing method according to claim 11, wherein, in the detection,
the sink is detected by detecting the phase inversion point in each of wobble periods of the predetermined number in the wobble signal, and
the number of the sinks is counted from the predetermined position, and it is determined that the position of the sink where the number of the sinks becomes a certain number is next the predetermined position.

19. An optical disk processing method comprising:
generating a wobble signal corresponding to a wobbled groove or an RF signal corresponding to storage information on an optical disk on the basis of a reflected light beam detected from the optical disk; and
adjusting the RF signal on the basis of the wobble signal.

20. An optical disk processing method according to claim 19, wherein at least one of a potential level and timing of the RF signal is adjusted on the basis of the wobble signal in the adjustment.
